(19) United States
(12) Patent Application Publication
(10) Pub. No.: US 2008/0173637 A1
(43) Pub. Date: Jul. 24, 2008

(54) INSULATED WATERPROOF HEATER

(76) Inventor: Koshiro Taguchi, Kanagawa-ken (JP)

Correspondence Address: PEARNE & GORDON LLP, 1801 EAST 9TH STREET, SUITE 1200, CLEVELAND, OH, 44114-3108, US

(21) Appl. No.: 12/020,822

(22) Filed: Jan. 28, 2008

(30) Foreign Application Priority Data
Nov. 2, 2005 (JP) 2005-319653
Nov. 2, 2005 (JP) 2005-319654

(51) Int. Cl. H05B 3/04

(52) U.S. Cl. 219/523

(57) ABSTRACT

An insulated waterproof-type heater includes: a heat-generating body unit including, an heat-generating element, an electrode member superposed in contact with the heat-generating element, an insulating sheet enveloping the heat-generating element and the electrode member, and a tubular body containing internally the heat-generating element and the electrode member that are enveloped in the insulating sheet; a heat-releasing body unit stacked on the heat-generating body unit; a cap mounted at an end of the heat-generating body unit; and a sealing material having an electrically insulating property and a waterproof property, and being filled inside the cap to seal both ends of the tubular body.

### CROSS-REFERENCE TO RELATED APPLICATIONS

This application is based upon and claimed the benefits of priorities from the prior Japanese Patent Application No. 2005-319653, filed on Nov. 2, 2005, and the prior Japanese Patent Application No. 2005-319654, filed on Nov. 2, 2005, the entire contents of which are incorporated herein by reference.

### BACKGROUND OF THE INVENTION

1. Field of the Invention

This invention relates to an insulated waterproof-type heater in which a current-carrying part is not exposed to the outside and the current-carrying part is waterproofed, and particularly, relates to the insulated waterproof-type heater in which a PTC (positive temperature coefficient) element is used as the heat-generating source.

2. Background Art

Conventionally, a heater in which the PTC element is used is well-known, for example, a heat-generating body unit as shown in JP-A 2001-351764.

This heat-generating body unit has a tubular body made of aluminum in which slits are formed along in the longitudinal direction on the upper surface part thereof, and inside the tubular body, a heat-generating element (PTC element) is disposed. One electrode plate is disposed on the upper surface of the heat-generating element, and on the lower surface, the other electrode plate is disposed.

Outside the both electrode plates, an insulating body consisting of a synthetic resin having a U-shaped cross section is disposed. The both ends of the tubular body are sealed by a cap. One end of one of electrode plate sticks out from the cap to be exposed outside the tubular body, and one end of the other electrode plate sticks out from the cap to be exposed outside the tubular body.

The case of using a heat-generating body unit disclosed in JP-A 2001-351764 in an environment requiring waterproof property admits of improvement. That is, some of the electrode plate, which is a current-carrying part, is exposed outside, and also, slits are formed over the entire length of the longitudinal direction of the tubular body, and through the slits, a liquid can infiltrate inside the tubular body in which the heat-generating element and the electrode plates are contained.

### SUMMARY OF THE INVENTION

According to an aspect of the invention, there is provided an insulated waterproof-type heater including: a heat-generating body unit including, an heat-generating element, an electrode member superposed in contact with the heat-generating element, an insulating sheet enveloping the heat-generating element and the electrode member, and a tubular body containing internally the heat-generating element and the electrode member that are enveloped in the insulating sheet; a heat-releasing body unit stacked on the heat-generating body unit; a cap mounted at an end of the heat-generating body unit; and a sealing material having an electrically insulating property and a waterproof property, and being filled inside the cap to seal both ends of the tubular body.

### BRIEF DESCRIPTION OF THE DRAWINGS

FIG. 1 is a side view of an insulated waterproof-type heater according to a first embodiment of the invention;

FIG. 2 is an upper view of the insulated waterproof-type heater shown in FIG. 1;

FIG. 3 is a left side view of the insulated waterproof-type heater shown in FIG. 1;

FIG. 4 is a right side view of the insulated waterproof-type heater shown in FIG. 1;

FIG. 5 is a plan view of a heat-generating body unit in the same insulated waterproof-type heater;

FIG. 6 is an enlarged cross-sectional view of the A-A line in FIG. 5;

FIG. 7 is a plan view of the substantial part in one end side of an electrode member in the same insulated waterproof-type heater;

FIG. 8 is an enlarged view of the electrode member shown in FIG. 7 viewed from the B-B line direction;

FIG. 9 is a plan view of a cap in the same insulated waterproof-type heater viewed from inside;

FIG. 10 is a cross-sectional view of the C-C line in FIG. 9;

FIG. 11 is a cross-sectional view of a heat-generating body unit in an insulated waterproof-type heater according to a second embodiment of the invention;

FIG. 12 is a cross-sectional view of a heat-generating body unit in an insulated waterproof-type heater according to a third embodiment of the invention;

FIG. 13 is a plan view of an insulated waterproof-type heater according to a fourth embodiment of the invention;

FIG. 14 is a schematic view showing the inside of caps in the same insulated waterproof-type heater in FIG. 13;

FIG. 15 is an enlarged plan view extracting one heater unit in the same insulated waterproof-type heater in FIG. 13;

FIG. 16 is a plan view of a heat-generating body unit in the same heater unit;

FIG. 17 is an enlarged cross-sectional view of the D-D line in FIG. 16; and

FIG. 18 is a schematic view showing the connecting part between the electrode member in the same heater unit and the cable for connecting outside.

### DETAILED DESCRIPTION OF THE INVENTION

Hereinafter, embodiments of the invention will be explained with reference to drawings.

### First Embodiment

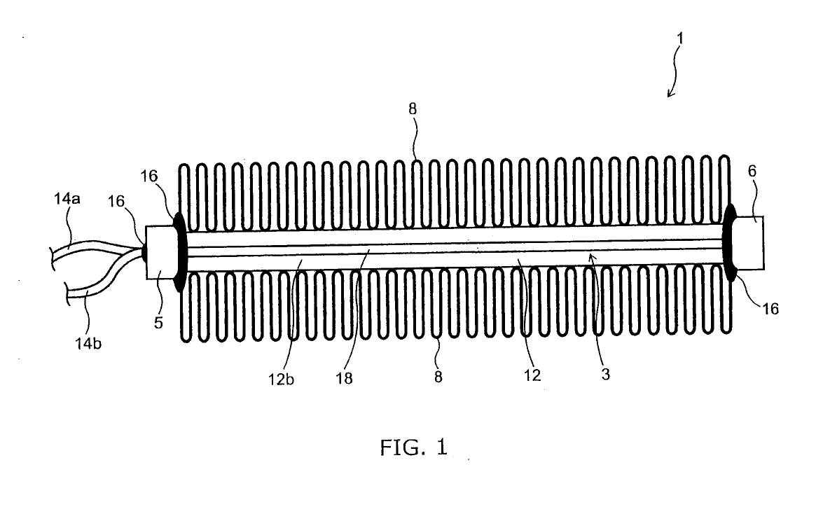

FIG. 1 is a side view of an insulated waterproof-type heater 1 according to a first embodiment of the invention.

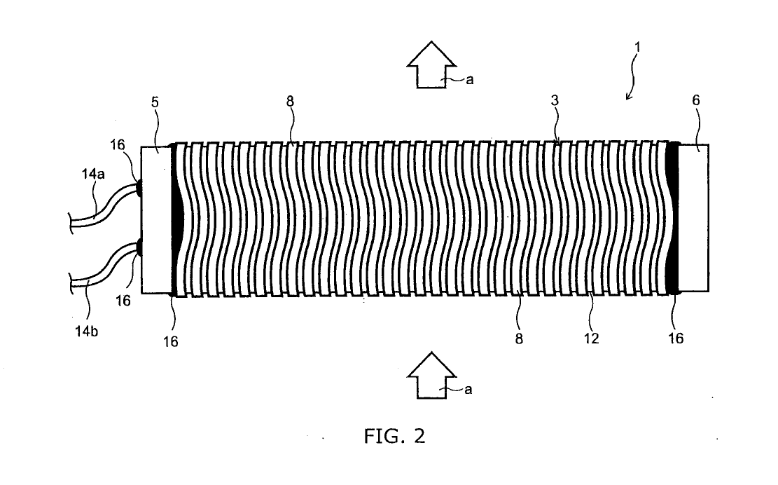

FIG. 2 is an upper view of the insulated waterproof-type heater 1 shown in FIG. 1.

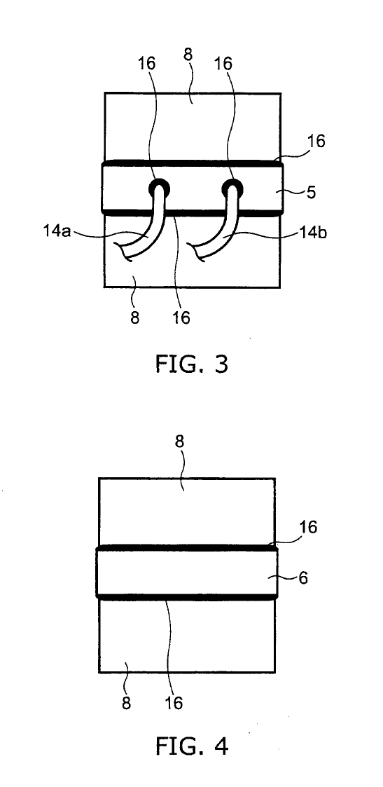

FIG. 3 is a view of the same insulated waterproof-type heater 1 viewed from the left side in FIG. 1.

FIG. 4 is a view of the same insulated waterproof-type heater 1 viewed from the right side in FIG. 1.

The insulated waterproof-type heater 1 according to this embodiment mainly includes, a heat-generating body unit 3 inside which a heat-generating element is contained, a fin 8 that is as a heat-releasing body unit provided on the heat-releasing surface of the heat-generating body unit 3, and a cap 5, 6 provided at each end of the heat-generating body unit 3.

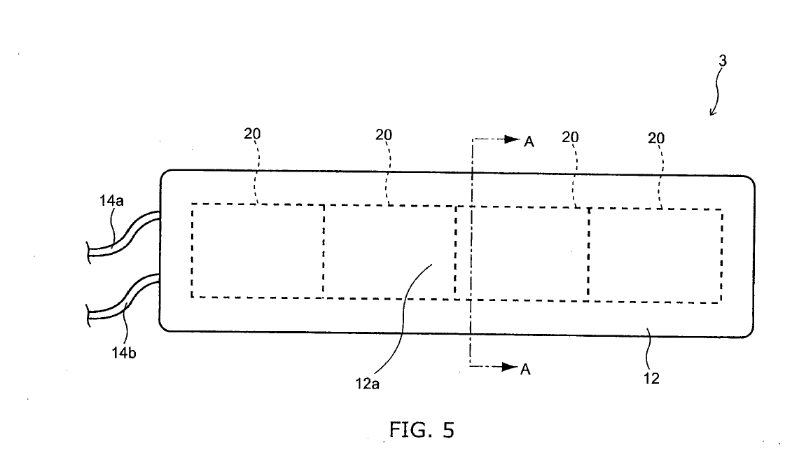

FIG. 5 is a plan view of the heat-generating body unit 3.

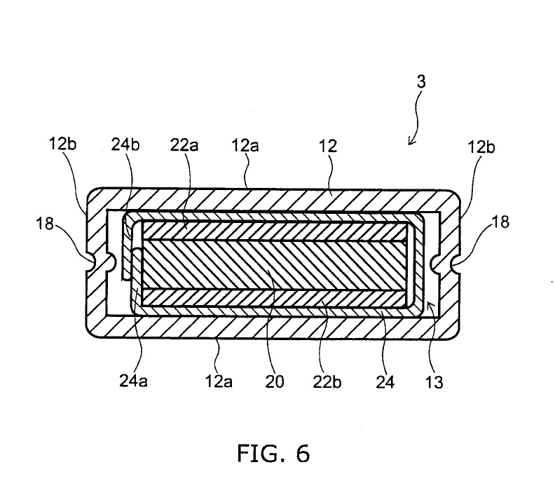

FIG. 6 is an enlarged cross-sectional view of the A-A line in FIG. 5.

The heat-generating body unit 3 includes, an heat-generating element 20, one pair of electrode members so as to sandwich the heat-generating element 20, an insulating sheet 24 enveloping the heat-generating element 20 and the electrode members 22a, 22b, and a tubular body 12 containing internally the heat-generating element 20 and the electrode members 22a, 22b that are enveloped in the insulating sheet 24.

The heat-generating element 20 is a PTC (positive temperature coefficient) ceramic element having a positive-temperature property, and when the temperature thereof becomes the Curie point or more, the resistance thereof sharply increases to restrict the farther temperature rise. As represented by the dashed line in FIG. 5, a plurality (for example, four in the representation) of the heat-generating elements 20 are disposed along the longitudinal direction of the tubular body 12. Each of the heat-generating elements 20 is formed, for example, in a rectangular thin-plate sectional shape. And, on each of the front and back surfaces thereof, an electrode surface made of metal such as silver or aluminum is formed. The thickness of the heat-generating element 20 is, for example, approximately 2 mm. On the electrode surfaces of the heat-generating element 20, the electrode members 22a, 22b are superposed to be contacted therewith, respectively.

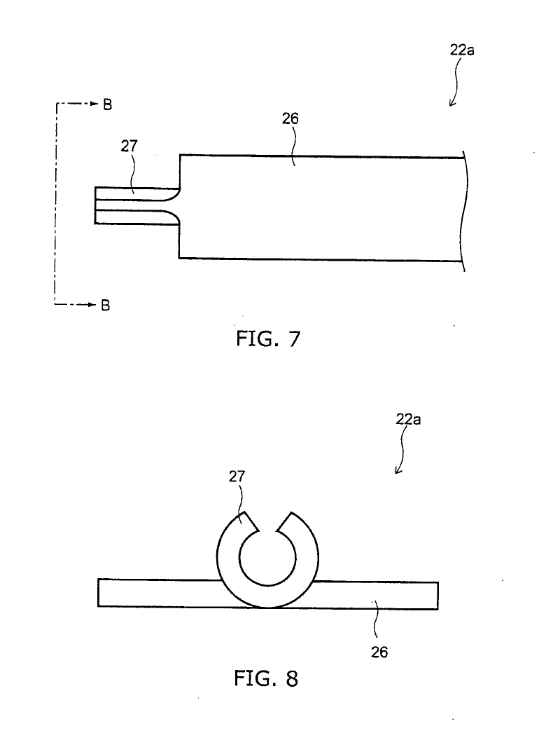

FIG. 7 is a plan view of the substantial part in one end side of the electrode member 22a.

FIG. 8 is an enlarged view of the electrode member 22a shown in FIG. 7 viewed from the B-B line direction.

Also, the electrode member 22b is composed in the same manner as the electrode member 22a shown in FIGS. 7, 8.

The electrode member 22 is made of metal material such as aluminum and has a flat-plate portion 26 with a band plate shape and has a terminal portion 27 provided integrally at one end of the flat-plate portion 26. The flat-plate portion 26 is superposed on the heat-generating element 20 in contact with an electrode surface of the heat-generating element 20. The heat-generating element 20 is sandwiched by one pair of electrode members 22a, 22b. The thickness of the flat-plate portion 26 is, for example, approximately 0.4 mm. The heat-generating element 20 and the flat-plate portion 26 are bonded with an adhesive having excellent heat conductivity such as silicone-based adhesive.

The electrode surfaces of the heat-generating element 20 are formed by spraying, for example, aluminum thereon, or by coating silver and then spraying aluminum thereon. Therefore, on the surfaces of the electrode surfaces, fine asperities are formed. Accordingly, although the adhesive for bonding the heat-generating element 20 to the flat-plate portion 26 of the electrode member has an insulating property, convex portions in the asperities come through the adhesive to be in contact with the flat-plate portion 26, and thereby, conductivity between the heat-generating element 20 and the electrode member can be ensured.

The terminal portion 27 is provided so as to stick out from the flat-plate portion 26 and is formed in a tubular shape whose one part in the circumferential direction is cut out. Inside the terminal portion 27 with the tubular shape, one end of a cable 14a shown in FIG. 5 is inserted, and the terminal portion 27 is crushed in to the diameter-reducing direction and thereby the one end of the cable 14a is fixed to the terminal portion 27. The cable 14a is composed by coating a conductive wire with a coating material. In the cable 14a, at least some of the conductive wire in the leading end side of the portion thereof to be fixed to the terminal portion 27 is exposed from the coating material and bonded to the terminal portion 27 through solder or the like. Accordingly, the electrode surface of the heat-generating element 20 is electrically connected to the cable 14a through the flat-plate portion 26 and the terminal portion 27. The other electrode member 22b is also electrically connected to a cable 14b in the same manner. The coating material of the cables 14a, 14b is made of a resin material having an electrically insulating property, a waterproof property, and a flexible property.

As shown in FIG. 6, the laminated body in which the heat-generating element is sandwiched by one pair of electrode members 22a, 22b is enveloped in an insulating sheet 24. The insulating sheet 24 has a flexible property, a thermal conductivity, and an electrically insulating property, and is made of, for example, a polyimide film with a thickness of 0.05 mm. Both edges 24a, 24b of the insulating sheet 24 are superposed on each other and the insulating sheet 24 completely covers the part except for both ends of the heat-generating element 20 and the electrode members 22a, 22b. The both edges 24a, 24b of the insulating sheet 24 are superposed not on the electrode members 22a, 22b but on the part opposed to a side surface of the heat-generating element 20 and the electrode members 22a, 22b. That is, the both edges 24a, 24b of the insulating sheet 24 are superposed on a back side of a side surface 12b of the tubular body 12.

The heat-generating element 20 and the electrode members 22a, 22b are contained in a hollow part 13 of the tubular body 12 with a rectangular tubular shape in the state that the part except for the both ends thereof is enveloped in the insulating sheet 24. The tubular body 12 is made of a material having heat conductivity and easy workability such as aluminum. Only in the both ends of the tubular body 12, openings are formed. Only through the openings of the both ends, the hollow part 13 can be in communication with the outside. Accordingly, when both ends of the tubular body 12 are blocked with a cap and sealing material to be described later, the hollow part 13 becomes a sealed space that is completely shielded from the outside.

The tubular body 12 has one pair of heat-releasing surfaces 12a that are generally parallel to each other and one pair of side surfaces 12b generally perpendicular to the heat releasing surface 12a. The heat-releasing surface 12a has a larger area than the side surface 12b. In the side surface 12b, a groove 18 is formed along the longitudinal direction as shown in FIG. 1.

The heat-generating element 20 is contained in the hollow part 13 so that the electrode surfaces thereof are opposed to the back surfaces of the heat-releasing surfaces 12a of the tubular body 12. Any one of the electrode members 22a, 22b and the insulating sheet 24 are made to lie between the electrode surface of the heat-generating element 20 and the back surface of the heat-releasing surface 12a. In the state before the assembling, the inside size of the tubular body 12 (size of the vertical direction in FIG. 6) is set to be slightly larger than that of the state shown in FIG. 6. And, the structural body in the state that the heat-generating element 20 and the electrode members 22a, 22b are assembled to be enveloped in the insulating sheet 24 is inserted into the tubular body 12, and mechanical pressure is applied to the heat-releasing surface 12a of the tubular body 12 to crush in the tubular body 12 in the vertical direction of FIG. 6, and thereby, the heat-generating element 20, the electrode members 22a, 22b, and the insulating sheet 24 are fixed in the hollow part 13 in the state of being narrowed between the back surfaces of the heat-releasing surface 12a of the tubular body 12.

The crushing amount of the tubular body 12 in this case is, for example, 0.5 mm. Here, because the groove 18 is formed along the longitudinal direction in both side surfaces 12b of the tubular body 12, when the tubular body 12 is crushed, the side surface 12b thereof can be prevented from swelling outside. That is, increase of the outer size thereof can be prevented. Because the side surface 12b of the tubular body 12 does not become a convex surface, it becomes easy to attach a temperature sensor such as thermocouple to the side surface 12b, and also stability after the attachment is good. The heat-releasing surface 12a is a plane surface and fins are attached onto the heat-releasing surface 12a as described later.

As shown in FIGS. 1-4, caps 5, 6 are attached to the both ends of the tubular body 12, respectively.

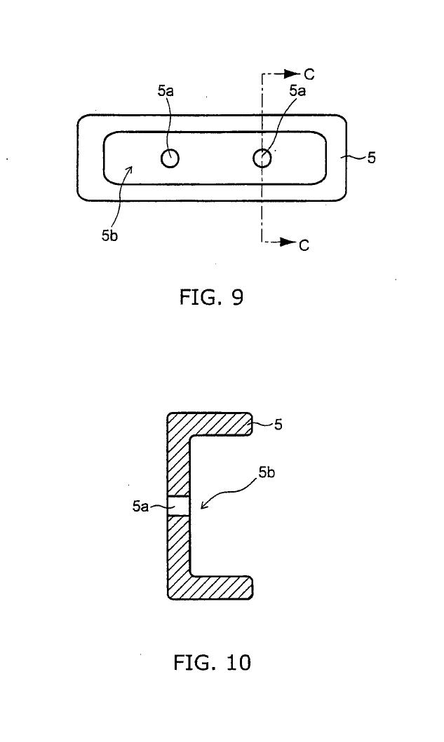

FIG. 9 is a plan view of one cap 5 viewed from inside.

FIG. 10 is a cross-sectional view of the C-C line in FIG. 9.

The cap 5 has an electrically insulating property and a heat resistance to heat generated from the heat-generating element 20, and for example, is made of PBT (polybutylene terephthalate). The cap 5 has a concave portion 5b into which one end of the tubular body 12 is inserted. And, in the bottom of the concave portion 5b, two through-holes 5a making the inside and the outside of the concave portion 5b be in communication with each other.

The cap 5 is mounted on one end of the tubular body 12. Specifically, after a sealing material having heat resistance and an electrically insulating property such as silicone material is filled in the concave portion 5b of the cap 5, one end of the tubular body 12 is fit into the concave portion 5b. In this case, as shown in FIGS. 1-3, a sealing material 16 inside the concave 5b protrudes outside the concave portion 5b to cover the gap between the cap 5 and the tube body 12. When the sealing material 16 is cured, the cap 5 and the tubular body 12 are fixed.

The cables 14a, 14b are passed through the two through-holes 5a formed in the cap 5 respectively, and the cables 14a, 14b are drawn out of the cap 5 through the through-holes 5a, and are connected to the external circuit, which is not shown. The sealing material 16 is also filled inside the through-holes 5a through which the cables 14a, 14b are passed, and some thereof protrudes outside the cap 5 from the through holes 5a and is cured with covering the gap between the cable 14a, 14b and the through-hole 5a.

The same cap 6 is also provided at the other end of the tubular body 12 but the through-holes 5a are not formed in this cap 6. Thereby, the hollow portion 13 of the tubular body 12 is liquid-tightly shielded from the outside by the caps 5, 6 and the sealing material 16.

As shown in FIGS. 1, 2, on the two heat-releasing surfaces 12a of the tubular body 12, fins 8 are provided, respectively. The fin 8 is folded in a shape in which mountain portions and valley portions are repeated. The fin 8 is fixed onto the heat-releasing surface 12a with an adhesive having excellent heat resistance and heat conductivity such as silicone-based adhesive. As shown in FIG. 2, fins 8 are bended not in a straight-line shape but in a wave shape along the lateral direction of the tubular body 12.

In the insulated waterproof-type heater 1 according to this embodiment that is composed as described above, the heat-generating element 20 is conducted with electricity and thereby to generate heat through the cables 14a, 14b and electrode members 22a, 22b. The heat generated from the heat-generating element 20 is conducted to the heat-releasing surface 12a of the tubular body 12 through the electrode members 22a, 22b and the insulating sheet 24 each of which has good heat conductivity, and conducted to fins 8 provided on the heat-releasing surfaces 12a. For example, the temperature of the heat-generating element 20 rises to approximately 230-240° C. and the temperature of the fins 8 becomes approximately 200° C.

The electrode members 22a, 22b are contained inside the tubular body 12 to be sealed with the caps 5, 6 and the sealing material 16 and are not exposed outside. Moreover, because the insulating sheet 24 is made to lie between the electrode members 22a, 22b, the tubular body 12 and the fins 8 are not conducted with electricity. Furthermore, the outside of the cable 14a, 14b is made of a coating material with an insulating property. Accordingly, the insulated waterproof-type heater 1 according to this embodiment has a structure in which the current-carrying part is not exposed outside.

Moreover, the tubular body 12 has a structure in which only both ends are opened but the structure is that the both ends are blocked by the caps 5, 6 and the gap between the cap 5, 6 and the tubular body 12 is sealed with the sealing material 16. That is, the inside of the tubular body 12 is completely shielded from the outside, and invasion of the liquid is not permitted.

As described above, the insulated waterproof-type heater 1 according to this embodiment has an excellent electrically insulating property and a waterproof property, and therefore is safe with no leakage even when used to be contacted with liquid, for example, immersed in liquid. For example, the heater is also suitable for use under a high-moisture environment such as a bathroom.

Moreover, as shown in FIG. 2, the fins 8 are bended in a wave shape, and therefore, for example, when the insulated waterproof-type heater 1 is placed along the extending direction of the fins 8 in the passage through which a liquid flows in the direction represented by the arrows a in FIG. 2, the contact time of the liquid and the fin 8 becomes long and heat transfer efficiency to the liquid from the fin 8 can be enhanced, compared to the case in which the fins 8 are straight along the flow direction a.

For the shape or the attachment direction of the fins 8, various modifications are possible. For example, in the specific examples exemplified in FIGS. 1 and 2, fins 8 have a suitable shape for the case in which gas or liquid is flowed in the width direction (direction of the arrows a in FIG. 2) of the heat-generating body unit 3. By contrast, the attachment direction of the fins 8 may be changed so as to flow gas or liquid in the longitudinal direction of the heat-generating body unit 3 (direction that is generally perpendicular to arrows a in FIG. 2).

Moreover, the fins 8 are not necessarily provided on the both sides of the heat-generating body unit 3, but may be provided only on one side thereof. That is, according to use application of the insulated waterproof-type heater 1, the fin 8 may be provided only on one side of the heat-generating body unit 3 and the other side of the heat-generating body unit 3 may remain the flat surface or may be bonded to another member.

Hereinafter, another embodiment of the invention will be explained, but the same components as the above-described first embodiment are appended with the same signs, and the specific explanation thereof is omitted.

### Second Embodiment

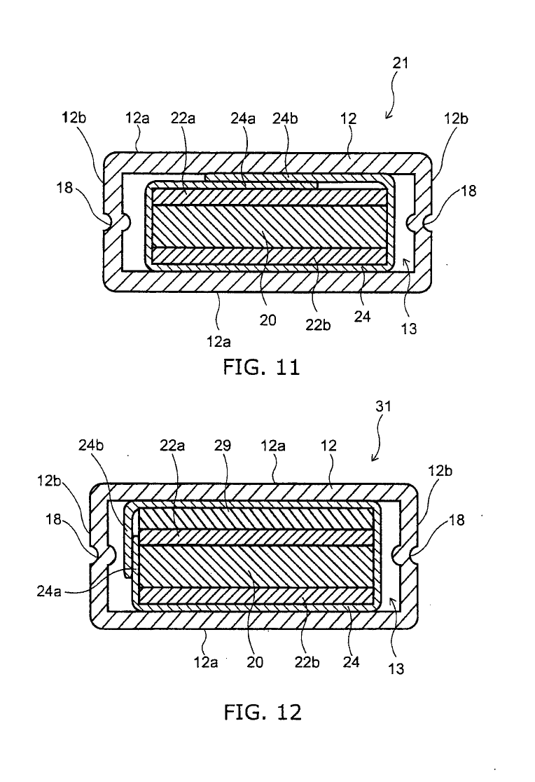

FIG. 11 is a cross-sectional view of a heat-generating body unit in an insulated waterproof-type heater 21 according to a second embodiment of the invention.

This insulated waterproof-type heater 21 is different from the above-described first embodiment, in the point that the both edges 24a, 24b of the insulating sheet 24 are superposed between the electrode member 22a and the back surface of the heat-generating surface 12a.

Considering the heat transfer efficiency from the heat-generating element 20 to the heat-releasing surface 12a, in the same manner as the above-described first embodiment, it is more desirable that the both edges 24a, 24b of the insulating sheet 24 are superposed on the part of the back side of the side surface 12b of the tubular body 12. The part between the electrode member 22a and the heat-releasing surface 12a exists in the heat-transferring passage from the heat element 20 to the heat-releasing surface 12a, and therefore, when the insulating sheet 24 is superposed doubly in this part, heat transfer is easily blocked to the extent of the superposition. Moreover, gaps are generated in the both sides of the part in which the insulating sheet 24 is superposed, and this can cause lowering of heat transfer efficiency from the heat-generating element 20 to the heat-releasing surface 12a.

In the case of the structure shown by FIG. 6, the power of 400 [W] could be obtained. By contrast, 370-380 [W] could be obtained in the case of the structure of FIG. 11. That is, in the structure of FIG. 11, it is difficult that heat of the heat-generating element 20 is conducted outside (particularly, to the upper direction in FIG. 11), and the power of the heat-generating element 20 that is a PTC element having a property of lowering the power by the temperature rising of itself comes to be lower by approximately 5-8%. However, for example, when the heat released from the heat-generating element 20 is intended to be taken out only to one side thereof (to the lower direction in FIG. 11), the structure of this embodiment can be adopted.

### Third Embodiment

FIG. 12 is a cross-sectional view of a heat-generating body unit in an insulated waterproof-type heater 31 according to a third embodiment of the invention.

In this insulated waterproof-type heater 31, a spacer 29 is superposed outside the electrode member 22a, and then, the heat-generating element 20, the electrode members 22a, 22b, and the spacer 29 are enveloped in the insulating sheet 24 to be contained in the hollow portion 13 of the tubular body 12, and then the tubular body 12 is crushed in.

The spacer 29 is made of a material having heat conductivity such as alumina or aluminum, and does not block heat transfer from the heat-generating element 20 to the heat-releasing surface 12a. The spacer 29 functions as a buffer material when the tubular body 12 is crushed in, and an excessive force is prevented from acting on the heat-generating element 20 to block damaging of the heat-generating element 20.

The insulated waterproof-type heaters according to the above-described embodiments are suitable when used in use application of heating liquid such as water or under the high-moisture environment. As such a use application, there can be exemplified various consumer equipment and industrial equipment including a heating heater for, heating of water bath for a tropical fish or the like, heating of various cleaning water of a dishwashing apparatus or the like, and heating in a bathroom heating drier.

In the above-described embodiments, the two cables 14a, 14b are not limited to be passed through the two through-holes 5a formed in the cap 5 shown in FIG. 9, respectively, and may be passed through one common through-hole. Moreover, the structure that one of the two cables 14a, 14b is drawn from the side of the cap 5 and that the other is drawn from the side of the cap 6 in the opposite side is also possible.

Moreover, it is not limited to crush in the tubular body 12 to narrow to press the heat-generating element 20, the electrode members 22a, 22b, and the insulating sheet 24, in the hollow part 13. It is also possible to bond to fix the members with an adhesive having heat conductivity.

The shape of the fins 8 is not limited to be in such a wave shape as shown in FIG. 2 and may be a straight-line shape. That is, in FIG. 2, it is also possible that the fins 8 do not bend along the direction of the arrows a and are formed straight. For example, when the heater is applied to the use application of heating air in such a case as used for drying and heating of a bathroom, it is desirable that the wind passage has a straight shape, from the viewpoint to suppress pressure loss and wind noise when the air passes through the fins 8.

Moreover, it is not limited to fix the fins 8 and the tubular body 12 with an adhesive, and the fixation may be performed by waxing or soldering.

Moreover, the fins 8 and the tubular body 12 are not limited to be made of aluminum. They can be composed of an aluminum alloy such as aluminum-magnesium alloy. In this case, such a fixating method as follows can be adopted.

The tubular body 12 made of aluminum or the like and the fins 8 made of aluminum-magnesium alloy or the like are immersed in flux and taken out thereof, and then, the extra flux is blown off with an air blow. Then, in the state that the tubular body 12 and the fins 8 are pressed and contacted, the temperature thereof is heated to 600° C. in an atmosphere of nitrogen gas, and thereby, the fins 8 and the tubular body 12 are bonded. The bonding has an advantage that degradation is difficult even under a high-moisture environment because of not using a general wax material for bonding aluminum materials, which has a tendency to change in quality to degrade under a high-moisture environment.

In the above-described bonding, the tubular body 12 does not contain the heat-generating element 20, the electrode members 22a, 22b, the insulating sheet 24, and so forth, and, the inside of the tubular body 12 is in an empty state, and the tubular body 12 and the fin 8 are bonded, and then, the heat-generating element 20 and the electrode members 22a, 22b which are enveloped in the insulating sheet 24 are inserted into the tubular body 12. Then, the tubular body 12 is crushed in the state of being attached with the fins 8, and thereby, the contained things such as the heat-generating element 20 are fixed inside the tubular body 12.

### Fourth Embodiment

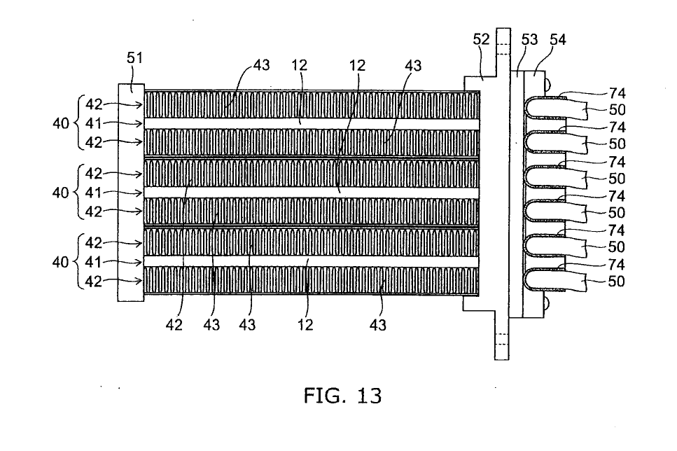

FIG. 13 is a plan view of an insulated waterproof-type heater according to a fourth embodiment of the invention.

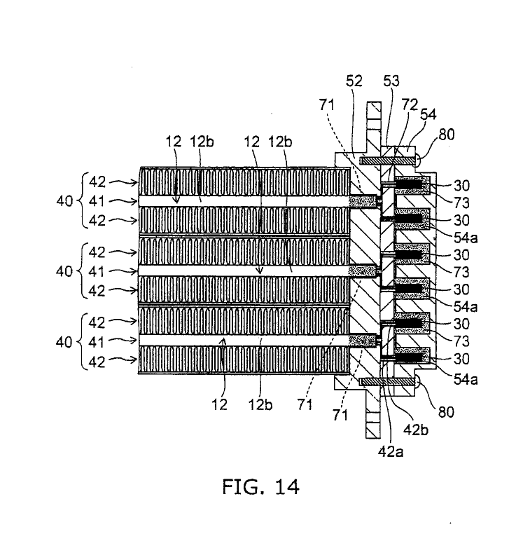

FIG. 14 is a schematic view showing the inside of caps 52-54 in the same insulated waterproof-type heater.

The insulated waterproof-type heater according to this embodiment is suitable for being used as an in-vehicle heater.

The insulated waterproof-type heater according to this embodiment has a structure in which a plurality of heat-generating body units 41 each containing the heat-generating element inside the tubular body 12 and a plurality of heat-releasing body units 42 each having fins 43 are stacked. For example, one heater unit 40 is composed by sandwiching one heat-generating body unit 41 with two heat-releasing body units 42.

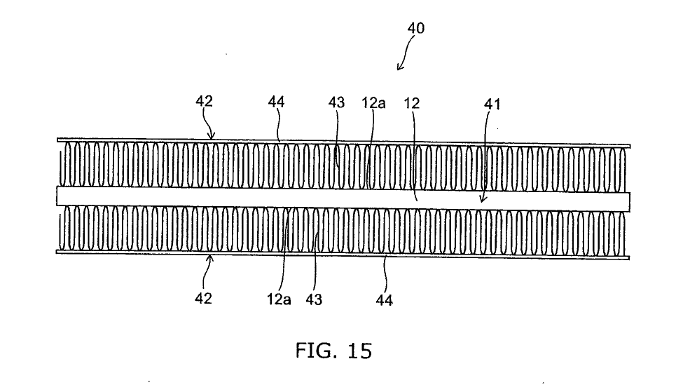

The insulated waterproof-type heater according to this embodiment has the structure in which, for example, three heater units 40 are stacked. In FIG. 15, one heater unit 40 is extracted and shown.

The heat-releasing body unit 42 has fins 43 and metal plates 44. The fin 43 is composed by folding a board material made of aluminum or the like in zigzags, and is provided between the metal plate 44 and the tubular body 12 of the heat-generating body unit 41.

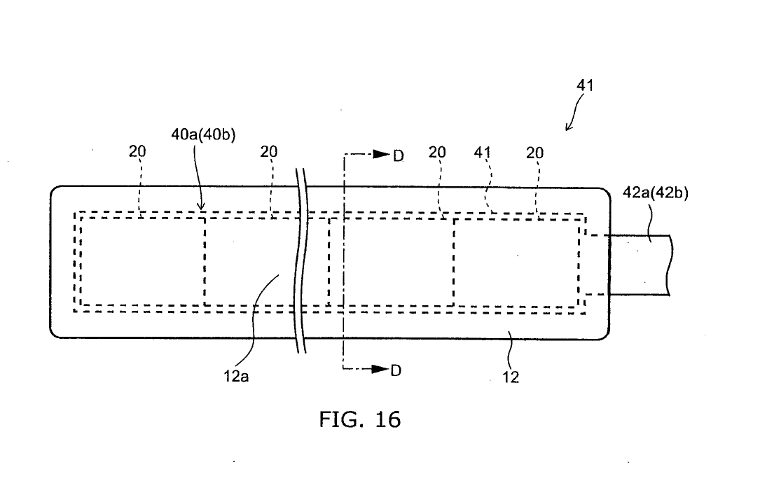

FIG. 16 is a plan view of the heat-generating body unit 41.

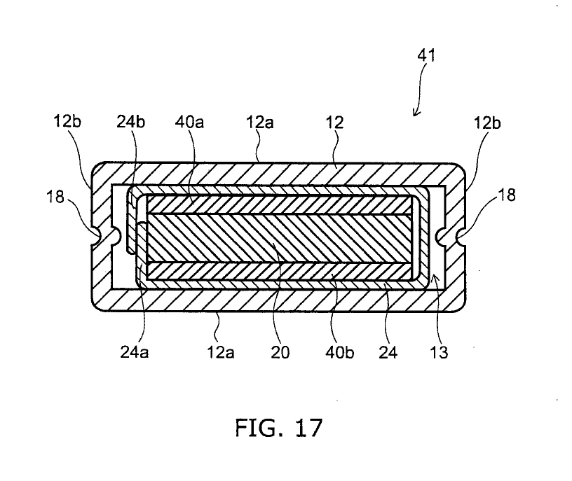

FIG. 17 is an enlarged cross-sectional view of the D-D line in FIG. 16.

The heat-generating body unit 41 includes an heat-generating element 20, one pair of electrode members 40a, 40b provided so as to sandwich the heat-generating element 20, an insulating sheet 24 enveloping the heat-generating element 20 and the electrode members 40a, 40b, and a tubular body 12 containing internally the heat-generating element 20 and the electrode members 40a, 40b that are enveloped in the insulating sheet 24.

The heat-generating element 20 is a PTC (positive temperature coefficient) ceramic element having a positive-temperature property in the same manner as the above-described embodiments, and when the temperature thereof becomes the Curie point or more, the resistance thereof sharply increases to restrict the farther temperature rise. As represented by the dashed line in FIG. 16, a plurality of the heat-generating elements 20 are disposed along the longitudinal direction of the tubular body 12. On each of the front and back surfaces of the heat-generating element 20, an electrode surface made of metal such as silver or aluminum is formed. On the electrode surfaces of the heat-generating element 20, the electrode members 40a, 40b are superposed to be contacted therewith, respectively. Voltage with reverse polarity is applied to each of the electrode members 40a, 40b.

The electrode member 40a is made of a metal such as aluminum and has a flat-plate portion 41 with a band plate shape and has a terminal portion 42a provided integrally at one end of the flat-plate portion 41. And, the other electrode member 40b is made of a metal such as aluminum and has a flat-plate portion 41 with a band plate shape and has a terminal portion 42b provided integrally at one end of the flat-plate portion 41.

The flat-plate portion 41 is superposed in contact with an electrode surface of the heat-generating element 20. The flat-plate portion 41 and the electrode surface of the heat-generating element 20 are bonded with an adhesive having excellent heat conductivity such as silicone-based adhesive.

The electrode surfaces of the heat-generating element 20 are formed by spraying, for example, aluminum thereon, or by coating silver and then spraying aluminum thereon. Therefore, on the electrode surfaces, fine asperities are formed. Accordingly, although the adhesive for bonding the heat-generating element 20 to the flat-plate portion 41 of the electrode member has an insulating property, convex portions in the asperities come through the adhesive to be in contact with the flat-plate portion 41, and thereby, conductivity between the heat-generating element 20 and the electrode member can be ensured.

The terminal portions 42a, 42b of the electrode members 40a, 40b stick outside the tubular body 12 from the end openings of one end side of the tubular body 12.

As shown in FIG. 17, the electrode members 22a, 22b and the heat-generating element 20 sandwiched therebetween are enveloped in the insulating sheet 24. The insulating sheet 24 has a flexible property, a thermal conductivity, and an electrically insulating property, and is made of a polyimide film or the like. Both edges 24a, 24b of the insulating sheet 24 are superposed on each other and the insulating sheet 24 completely covers the part except for both ends of the heat-generating element 20 and the electrode members 40a, 40b. The both edges 24a, 24b of the insulating sheet 24 are superposed not on the electrode members 40a, 40b but on the part opposed to a side surface of the heat-generating element 20 and the electrode members 40a, 40b. That is, the both edges 24a, 24b of the insulating sheet 24 are superposed not on a heat-releasing surface 12a but on the back side of the side surface 12b of the tubular body 12, in the tubular body 12.

The heat-generating element 20 and the electrode members 40a, 40b are contained in a hollow part 13 of the tubular body 12 in the state that the part except for the both ends thereof is covered (enveloped) with the insulating sheet 24. Only in the both ends of the tubular body 12, openings are formed. Only through the openings of the both ends, the hollow part 13 can be in communication with the outside.

The electrode surfaces of the heat-generating element 20 are opposed to the back surfaces of the heat-releasing surfaces 12a of the tubular body 12. And, between the electrode surface thereof and the back surface of the heat-releasing surface 12a, any one of the electrode members 40a, 40b and the insulating sheet 24 are made to lie. In the state before the assembling, the inside size of the tubular body 12 (size of the vertical direction in FIG. 17) is set to be slightly larger than that of the state shown in FIG. 17. And, the structural body in the state that the heat-generating element 20 and the electrode members 40a, 40b are assembled to be enveloped in the insulating sheet 24 is inserted into the tubular body 12, and mechanical pressure is applied to the heat-releasing surface 12a of the tubular body 12 to crush in the tubular body 12 in the vertical direction of FIG. 17, and thereby, the heat-generating element 20, the electrode members 40a, 40b, and the insulating sheet 24 are fixed in the hollow part 13 in the state of being narrowed between the back surfaces of one pair of the heat-releasing surface 12a of the tubular body 12.

Also, in this embodiment, because a groove 18 is formed along the longitudinal direction in both side surfaces 12b of the tubular body 12, when the tubular body 12 is crushed, the side surface 12b thereof can be prevented from swelling outside (increase of the outer size).

As shown in FIG. 15, the metal plates 44 of the heat-releasing body unit 42 are generally parallel to the heat-releasing surfaces 12a of the tubular body 12, and the fins 43 are provided between the metal plate 44 and the heat-releasing surface 12a.

The metal plate 44 is formed in a thin-plate shape having a plane with the generally same area as the heat-releasing surface 12a, and is made of metal having excellent heat conductivity such as aluminum. The metal plate 44 and the fin 43 are adhesively fixed to each other with an adhesive having excellent heat resistance and heat conductivity such as silicone-based adhesive. Similarly, the fin 43 and the heat-releasing surface 12a are adhesively fixed to each other with an adhesive having excellent heat resistance and heat conductivity such as silicone-based adhesive.

And, the metal plate 44 is adhered to a metal plate 44 of another heater unit 40 with an adhesive having excellent heat resistance and heat conductivity such as silicone-based adhesive, and thereby, as shown in FIG. 13, the structure in which a plurality (three in the shown example) of heater units 40 are stacked can be obtained.

On one end of this stacked structural body, three caps 52-54 are mounted, and a cap 51 is mounted on another end thereof. By these caps 51-54, the hollow parts of the tubular body 12 are blocked. Each of the caps 51-54 is made of a resin material having heat-resistance and an electrically insulating property.

Inside each of the caps 51-54, a sealing material having an electrically insulating property, a waterproof property, and heat resistance (heat resistance for the temperature such as 200-250° C.) such as silicone material is filled, and both ends of the tubular body 12 are sealed by the sealing material.

One end of each of described one pair of the electrode members 40a, 40b of each of the heater units 40 functions as the terminal portions 42a, 42b and is guided to the outside of the tubular body 12 from an end opening of the tubular body 12. The terminal portions 42a, 42b are separated to each other and are not contacted with each other (not short-circuited), and one of the terminal portions 42a, 42b is connected to the power line, and the other is connected to the ground line.

Before mounting the caps 52-54, a sealing material 71 in which a material having an electrically insulating property, a waterproof property, and heat resistance such as silicone-based resin is used is implanted into the inside from the end openings of the side in which the terminal portions 42a, 42b are guided to the outside, and the sealing material 71 is filled inside the end opening of the tubular body 12 to block the end opening.

The sealing material 71 is filled and then sufficiently dried to be cured. Then, a first inner cap 52 is mounted at one end of the heater units 40. The first inner cap 52 is adhesively fixed to one ends of the heater units 40 with an adhesive having heat resistance.

The one ends of the heat-generating body units 41 stick out with respect to the one ends of the heat-releasing body units 42, and the one ends of the heat-releasing body units 42 are fit into concave portions formed in the first inner cap 52, and the one ends of the heat-generating body units 41 are inserted into through-holes formed penetratingly from the bottom of the concave portions to the opposite end face thereof. The terminal portions 42a, 42b pass through the through-holes of the first inner cap 52 and stick outside the first inner cap 52.

Next, the terminal portions 42a, 42b are bended and a second inner cap 53 is mounted to the first inner cap 52 so as to cover the bended portions by using an adhesive or the like. In the terminal portions 42a, 42b, portions in the near side to the end openings of the tubular body 12 are bended, and portions in the leading end side pass through through-holes formed in the second inner cap 53 to stick outside the second inner cap 53.

The terminal portions 42a, 42b are bended generally perpendicularly from the vicinity portion of the end opening of the tubular body 12 to the portion passed through the inside of the second inner cap 53. One pair of terminal portions 42a, 42b of each of the heat-generating body units 41 are bended so as to be broadened separate to each other in the stacking direction of the plurality of heat-generating body units 41 and the plurality of heat-releasing body units 42 (in the vertical direction in the paper of FIG. 14). Furthermore, the end portions of the terminal portions are bended generally perpendicularly to the outside of the cap (right in FIG. 14), and the bended portions are passed through the through-holes formed in the second inner cap 53.

In the one pair of terminal portions 42a, 42b of each of the heat-generating body units 41, the distance separate to each other of the portions sticking outside though the inside of the second inner cap 53 is broadened larger than the opposing distance between the one pair of electrode members 40a, 40b opposed to each other with sandwiching the heat-generating element 20 described above with reference to FIG. 17. Furthermore, the separate distance is broadened larger than the width of the side surface 12b of the tubular body 12. When viewed in the longitudinal direction of the second inner cap 53, a plurality (for example, six in this embodiment) of terminal portions 42a, 42b are located to be dispersed so that the positions thereof are not biased.

In mounting the second inner cap 53, preliminarily before the mounting, a sealing material 72 having an electrically insulating property, a waterproof property, and heat resistance is coated on the portion of the terminal portions 42a, 42b that is set inside the second inner cap 53 through the bended portion from the vicinity of the end opening of the tubular body 12. The terminal portions 42a, 42b coated with the sealing material 72 are passed through the second inner cap 53 to mount the second inner cap 53.

Thereby, in the structure, the sealing materials 71, 72 are filled from the through-holes of the second inner cap 53 to the inside of the vicinities of the end openings of the tubular body 12. That is, the guiding passages of the terminal portions 42a, 42b from the inside of the vicinities of the end openings of the tubular body 12 to the through-holes of the second inner cap 53 are sealed with the sealing materials 71, 72, and the terminal portions 42a, 42b existing in the guiding passages are covered with the sealing materials 71, 72 to be waterproof-sealed.

The leading ends of the terminal portions 42a, 42b sticking outside from the second inner cap 53 are electrically connected to cables 50 shown in FIG. 13 through connecting members.

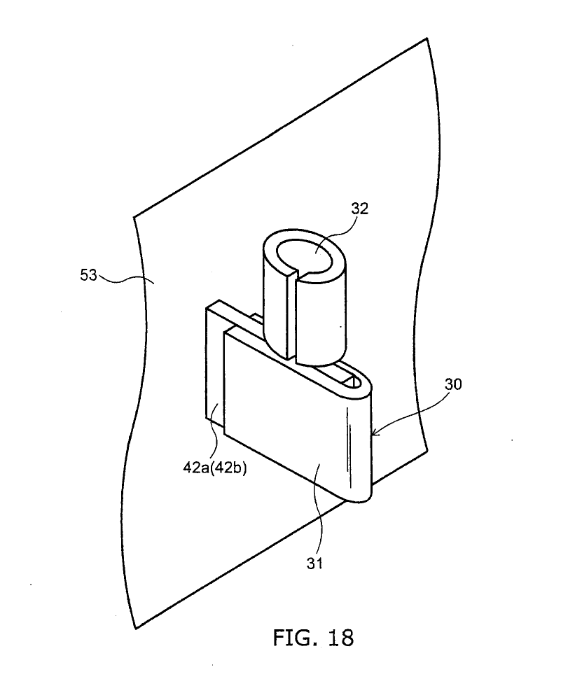

FIG. 18 schematically shows the state in which a connecting member 30 is attached to each of the terminal portions 42a, 42b.

The connecting member 30 includes an attachment portion 31 folded into two to sandwich the leading end of each of the terminal portions 42a, 42b and attached to the leading end of each of the terminal portions 42a, 42b and a cable-inserted portion 32 with a generally C-shaped cross-section provided integrally on the upper portion the attachment portion 31.

Inside the cable-inserted portion 32, one end of the cable 50 shown in FIG. 13 is inserted, and the cable-inserted portion 32 is collapsed in the diameter-reducing direction to fix the one end of the cable 50 to the cable-inserted portion 32. In the cable 50, a conductive wire is coated with a coating material consisting of, for example, resin. In this cable 50, at least one part in the leading end side of a portion of the conductive wire to be fixed to the cable-inserted portion 32 is exposed from the coating material and in contact with the cable-inserted portion 32. Thereby, electric power is supplied to the electrode surfaces of the heat-generating element 20 inside the tubular body 12 through the cable 50, the connecting members 30, and the terminal portions 42a, 42b of the electrode members 40a, 40b.

After the above-described connecting member 30 is attached to each of the terminal portions 42a, 42b, an outer cap 54 is mounted onto the second inner cap 53. In mounting the outer cap 54, preliminarily a sealing material 73 having an electrically insulating property, a waterproof property, and heat resistance is coated inside the outer cap 54, and the outer cap 54 is mounted to cover the end surface of the second inner cap 53 with internally containing the sealing material 73.

As shown in FIG. 14, the above-described first inner cap 52, the second inner cap 53, and the outer cap 54 are fastened one another by screws 80 screwed from the side of the outer cap 54. The terminal portions 42a, 42b sticking out from the end face from the second inner cap 53 and the connecting members 30 attached thereto are contained inside the outer cap 54. Because the sealing material 73 is then preliminarily coated inside the outer cap 54 as described above, the terminal portions 42a, 42b and connecting members 30 are located inside the outer cap 54 and waterproof-sealed, in the state of being covered with the sealing material 73. In this case, by the fastening force by the screws 80, the outer cap 54 is pressed into the side of the second inner cap 53, and also, the sealing material 73 contained inside the cap is pressed into the side of the second inner cap 53, and the terminal portions 42a, 42b and the connecting members 30 can be certainly covered with the sealing material 73 without a gap.

In the outer cap 54, cutouts 54a are formed, correspondingly to the number of the terminal portions 42a, 42b, and the connecting members 30 are exposed to the outside though the cutouts 54a and connected to the cables 50 shown in FIG. 13.

After the connecting member 30 and the cable 50 are connected, the connecting part is covered with a sealing material 74 having electrically insulating property, waterproof property, and heat resistance such as silicone material.

The insulated waterproof-type heater according to this embodiment that is composed as described above is used, for example, as a so-called heater for a car air conditioner with being mounted on an automobile. For example, the insulated waterproof-type heater according to this embodiment is disposed in a passage in which an air flow is formed by taking air of the car exterior or car interior in the automobile, and disposed so that the air can pass between the fins 43 and so that the air can flow in the direction passing through the page in FIG. 13.

And, the power from the battery mounted on the automobile is supplied to the heat-generating element 20 through a not-shown control circuit, the cables 50, the connecting members 30, and the electrode members 40a, 40b, and thereby the heat-generating element 20 generates heat. The heat generated by the heat-generating element 20 is conducted to the heat-releasing surfaces 12a of the tubular body 12 through the electrode members 40a, 40b and the insulating sheet 24, every one of which has heat conductivity. And, furthermore, the heat is conducted to the fins 43 provided on the heat-releasing surfaces 12a. The air flows between the fins 43 and thereby the temperature of the air is raised and supplied to the inside of the car room.

And, in this embodiment, the heat-generating element 20 and the electrode members 40a, 40b being in contact with the electrode surfaces thereof are contained inside the tubular body 12 sealed by the caps 52-54. And, the terminal portions 42a, 42b of the electrode members 40a, 40b playing electrical connection to the exterior and the guiding passages thereof have a structure of being covered with the waterproof sealing materials 71-74, and therefore, the current-carrying parts thereof are not exposed to the outside and are waterproof-sealed. Furthermore, the insulating sheet 24 is made to lie between the electrode member 40a, 40b and the tubular body 12, and thereby the electrode member and the tubular body are insulated and separated, and therefore the tubular body 12, the fin 43, and the metal plate 44 are not conducted with electricity.

As described above, the insulated waterproof-type heater according to this embodiment has a structure in which the current-carrying parts are not exposed to the outside and are waterproof-sealed. If rainwater, snow, dust, dirt, or the like is contaminated in the air sent to this heater, the heater is safe without leakage of electricity.

For example, even in the condition in which a vehicle is immersed in water by flood or the like, troubles due to an electric shock can be prevented.

Moreover, a conventional in-vehicle heater has a structure in which a heat-releasing body unit such as a fin exposed to the outside is conducted with electricity, and therefore, a housing such as a barrier for an electric shock stop is required. However, in the insulated waterproof-type heater according to this embodiment, such a housing is not required, and the heater contributes to a total material reduction, space reduction, and cost reduction.

Moreover, in the heater according to this embodiment, the plurality of units are adhesively fixed to one another to be the integrated stacked structure bodies and to be a structure in which the both ends of the stacked structure bodies are fit into caps, and therefore, the units are strongly fixed to one another, and the mechanical strength and the vibration resistance are excellent in the entirety of the in-vehicle heater, and particularly, rattle vibration, damage, and separation of each of the units due to vibration received in driving on a bad road or the like can be prevented.

Furthermore, the terminal portions 42a, 42b of the electrode members 40a, 40b guided to the outside of the tubular body 12 from the end opening of the tubular body 12 are bended and passed through the inner cap 53, and therefore, the movements of the inner cap 53 in the horizontal direction on the page (direction in which the inner cap 53 separates from the inner cap 52) and in the vertical direction thereon (direction in which the inner cap 53 shifts in the stacking direction of each of the units) are regulated by the bend portions of the terminal portions 42a, 42b, and rattling of the inner cap 53 is suppressed.

As a result, rattling of the inner cap 52 and the outer cap 54 that are mounted to sandwich the inner cap 53 is also suppressed. Breaking of the terminal portions 42a, 42b located inside the caps, separation between the terminal portion 42a, 42b and the connecting member 30, and separation between the connecting member 30 and the cable 50, can be prevented.

Moreover, the metal plate 44 composing the heat-releasing body unit 42 with the fins 43 not only strengthens the fins 43 but also functions as a strengthening plate for enhancing the mechanical strength of the entirety of the stacked structure bodies of the respective units, and these functions contribute to improvement of vibration resistance.

In the above explanations, there has been explained the structure in which three heater units 40 each having, as one unit, the structure in which one heat-generating body unit 41 is sandwiched by two heat-releasing body units 42, namely, the stacked structure of three heat-generating body units 41 and six heat-releasing body units 42. However, the number of the heat-releasing body units 42 in one heater unit 40 and the number of the units in the entire stacked structure are not limited to the above-described numbers, respectively.

Also, the structure in which the terminal portions 42a, 42b of the electrode members 40a, 40b guided to the outside of the tubular body 12 from the end openings of the tubular body 12 are linearly passed through the inner cap 53 without being bended is possible. However, particularly, considering vibration resistance in the use application for vehicle, the structure in which the terminal portions 42a, 42b are bended as described above is desirable.

1. An insulated waterproof-type heater comprising:
a heat-generating body unit including, an heat-generating element, an electrode member superposed in contact with the heat-generating element, an insulating sheet enveloping the heat-generating element and the electrode member, and a tubular body containing internally the heat-generating element and the electrode member that are enveloped in the insulating sheet;
a heat-releasing body unit stacked on the heat-generating body unit;
a cap mounted at an end of the heat-generating body unit; and
a sealing material having an electrically insulating property and a waterproof property, and being filled inside the cap to seal both ends of the tubular body.

2. The insulated waterproof-type heater according to claim 1, wherein the electrode member is connected to a cable coated with a coating material having an electrically insulating property and a waterproof property, the cable is passed through the cap and guided to the outside of the cap, and the sealing material blocks a gap between the cable and the cap.

3. The insulated waterproof-type heater according to claim 1, wherein the electrode member is guided from an end opening of the tubular body to the outside of the cap and has a terminal guided to the outside of the cap, and the terminal is coated with the sealing material.

4. The insulated waterproof-type heater according to claim 1, wherein the heat-generating element is a PTC (positive temperature coefficient) ceramic element.

5. The insulated waterproof-type heater according to claim 1, wherein a spacer having heat conductivity is made to lie between the electrode member and the insulating sheet, inside the tubular body.

6. The insulated waterproof-type heater according to claim 1, wherein the tubular body has a heat-releasing surface that the heat-releasing body unit is stacked in and a side surface that is generally perpendicular to the heat-releasing surface, and both edges of the insulating sheet are superposed in a back side of the side surface.

7. The insulated waterproof-type heater according to claim 6, wherein a groove is formed in the side surface of the tubular body.
